(19) United States
(12) Patent Application Publication
(10) Pub. No.: US 2025/0276414 A1
(43) Pub. Date: Sep. 4, 2025

(54) MOUNT FOR A MACHINING PLATFORM

(71) Applicant: Chick Workholding Solutions, Inc., Warrendale, PA (US)

(72) Inventor: Jeffrey M. Warth, Mars, PA (US)

(21) Appl. No.: 18/591,846

(22) Filed: Feb. 29, 2024

(51) Int. Cl. B23Q 1/03

(52) U.S. Cl. CPC B23Q 1/03

(57) ABSTRACT

A mount for a machining platform is disclosed. The mount can comprise a body, a first clamp, a second clamp, and a drive screw rotatably mounted to the body. The first clamp and the second clamp can both comprise a clamp body and a protrusion comprising a shoulder. The drive screw can comprise a first external threaded length threadably engaged with a first internal threaded length of the first clamp. The first external threaded length comprises first threads. The drive screw can further comprise a second external threaded length threadably engaged with a second internal threaded length of the second clamp. The second external threaded length comprises second threads oriented in the opposite direction of the first threads. The shoulders move away from each other upon a rotation of the drive screw.

### SUMMARY

In various aspects, a mount for a machining platform, the mount comprising a body, a first clamp movable relative to the body, a second clamp movable relative to the body, and a drive screw rotatably mounted to the body, is disclosed. The first clamp comprises a first clamp body defining a first opening comprising a first internal threaded length. The first clamp further comprises a first protrusion comprising a first shoulder. The second clamp comprises a second clamp body defining a second opening comprising a second internal threaded length. The second clamp further comprises a second protrusion comprising a second shoulder. The drive screw comprises a first external threaded length threadably engaged with the first internal threaded length of the first clamp. The first external threaded length comprises first threads. The drive screw further comprises a second external threaded length threadably engaged with the second internal threaded length of the second clamp. The second external threaded length comprises second threads oriented in the opposite direction of the first threads. The first shoulder and the second shoulder move away from each other upon a rotation of the drive screw.

In various aspects, a mount for a machining platform, the mount comprising a body, a first clamp movable relative to the body, a second clamp movable relative to the body, and a drive screw rotatably mounted to the body, is disclosed The first clamp comprises a first clamp body defining a first threaded opening. The first clamp further comprises a first protrusion comprising a first shoulder. The second clamp comprises a second clamp body defining a second threaded opening. The second clamp further comprises a second protrusion comprising a second shoulder. The first shoulder and the second shoulder face away from each other. The drive screw comprises a plurality of first external right-hand threads threadably engaged with the first threaded opening of the first clamp. The drive screw further comprises a plurality of second external left-hand threads threadably engaged with the second threaded opening of the second clamp. The first shoulder and the second shoulder simultaneously move away from each other upon a rotation of the drive screw.

In various aspects, a mounting system comprising a body, a first clamp movable relative to the body, a second clamp movable relative to the body, and a drive screw rotatably mounted to the body is disclosed. The first clamp comprises a first clamp body defining a first threaded opening. The first clamp further comprises a first protrusion comprising a first shoulder. The second clamp comprises a second clamp body defining a second threaded opening. The second clamp further comprises a second protrusion comprising a second shoulder. The first shoulder and the second shoulder face away from each other. A plane of symmetry is defined between the first clamp and the second clamp. The drive screw comprises a plurality of first external threads threadably engaged with the first threaded opening of the first clamp. The drive screw further comprises a plurality of second external threads threadably engaged with the second threaded opening of the second clamp. The first shoulder and the second shoulder move from a first configuration to a second configuration upon a rotation of the drive screw. The first clamp and the second clamp are equidistantly spaced from the plane of symmetry in the first configuration and in the second configuration.

### BRIEF DESCRIPTION OF THE FIGURES

The features of various aspects are set forth with particularity in the appended claims. The various aspects, however, both as to organization and methods of operation, together with further objects and advantages thereof, may best be understood by reference to the following description, taken in conjunction with the accompanying drawings as follows:

FIG. 1 is a perspective view of a mount for a machining platform, illustrating several workpiece holders that are compatible with the mount, in accordance with at least one aspect of the present disclosure.

FIG. 2 is a perspective view of different adapters of varying sizes and configurations, the adapters are compatible with corresponding workpiece holders and the mount of FIG. 1, in accordance with at least one aspect of the present disclosure.

FIG. 3 is perspective view of the mount of FIG. 1 attached to a pallet plate of a machining platform, depicting a workpiece holder with an adapter attached thereto positioned between the mount and the workpiece holder, in accordance with at least one aspect of the present disclosure.

FIG. 4 is a perspective view of the adapter of FIG. 3, in accordance with at least one aspect of the present disclosure.

FIG. 5 is another perspective view of the adapter of FIG. 3, depicting receptacles defined in the adapter for receiving protrusions of the mounting device, in accordance with at least one aspect of the present disclosure.

FIG. 6 is an exploded view of the mount of FIG. 3, depicting a base portion, a cover plate, and a pair of clamp assemblies, wherein each clamp assembly includes a pair of clamps and a protrusion for each clamp, in accordance with at least one aspect of the present disclosure.

FIG. 7 is a perspective view of the different base portions for the mount, in accordance with at least one aspect of the present disclosure.

FIG. 8 is a perspective view of the mount of FIG. 3 with the cover plate removed, depicting the pair of clamp assemblies attached to the base, in accordance with at least one aspect of the present disclosure.

FIG. 9 a plan view of the mount of FIG. 3 with the cover plate removed, depicting the pair of clamp assemblies attached to the base, in accordance with at least one aspect of the present disclosure.

FIG. 10 is a perspective view of the pair of clamp assemblies of the mount of FIG. 3, in accordance with at least one aspect of the present disclosure.

FIG. 11 is a perspective view of one of the clamp assemblies of FIG. 8, in accordance with at least one aspect of the present disclosure.

FIG. 12 is another perspective view of the clamp assembly of FIG. 11 in accordance with at least one aspect of the present disclosure.

FIG. 13 is a cross section view of the clamp assembly of FIG. 11, in accordance with at least one aspect of the present disclosure.

FIG. 14 is a side elevation view of a drive screw of the clamp assembly of FIG. 11, in accordance with at least one aspect of the present disclosure.

FIG. 15 is cross section view of the workpiece holder, the adapter, and the mount of FIG. 3, depicting the protrusions of the mount positioned within receptacles of the adapter, and further depicting the clamps in a first configuration, in accordance with at least one aspect of the present disclosure.

FIG. 16 is cross section view of the workpiece holder, the adapter, and the mount of FIG. 3, depicting the clamps of the mount positioned within receptacles of the adapter, and further depicting the clamps in a second configuration, in accordance with at least one aspect of the present disclosure.

FIG. 17 is a perspective view of two different adapters, each adapter having a blank surface for customization, in accordance with at least one aspect of the present disclosure.

FIG. 18 is a perspective view of two different adapters, each adapter having a plurality of mounting holes defined therein, in accordance with at least one aspect of the present disclosure.

FIG. 19 is a perspective view of the mount of FIG. 1, depicting the mount attached to a T-slotted machining table, and further depicting an adapter positioned above the mount, in accordance with at least one aspect of the present disclosure.

FIG. 20 is a perspective view of a mount, depicting the mount mounted to a pallet plate on an indexer with a workpiece holder positioned above the mount, in accordance with at least one aspect of the present disclosure.

FIG. 21 is a perspective view of the mount of FIG. 20, depicting the mount mounted to the indexer with the workpiece holder mounted to the mount, in accordance with at least one aspect of the present disclosure.

### DETAILED DESCRIPTION

Before explaining various aspects of the mount in detail, it should be noted that the illustrative examples are not limited in application or use to the details of construction and arrangement of parts illustrated in the accompanying drawings and description. The illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects and/or examples.

In general, milling machines are used within the metal working industry. Milling machines can utilize removable pallets as a platform to mount materials or fixtures. Installing workpiece holders and fixtures to the milling machines can consume significant set-up time and can require a special set of skills. Various systems in the industry for mounting workpiece holders are referred to as “Zero Point Setting” systems. These systems are limited by their strength and rigidity in many applications. For example, most of these systems are designed to grasp one or more locating pins. The mount and/or mounting systems described herein provide for quick change, accurate fixture installation with a high clamping force and provide a rigid connection. In at least one aspect, the high rigidity allows larger fixtures (e.g., workpiece holders) to be installed to machining platforms.

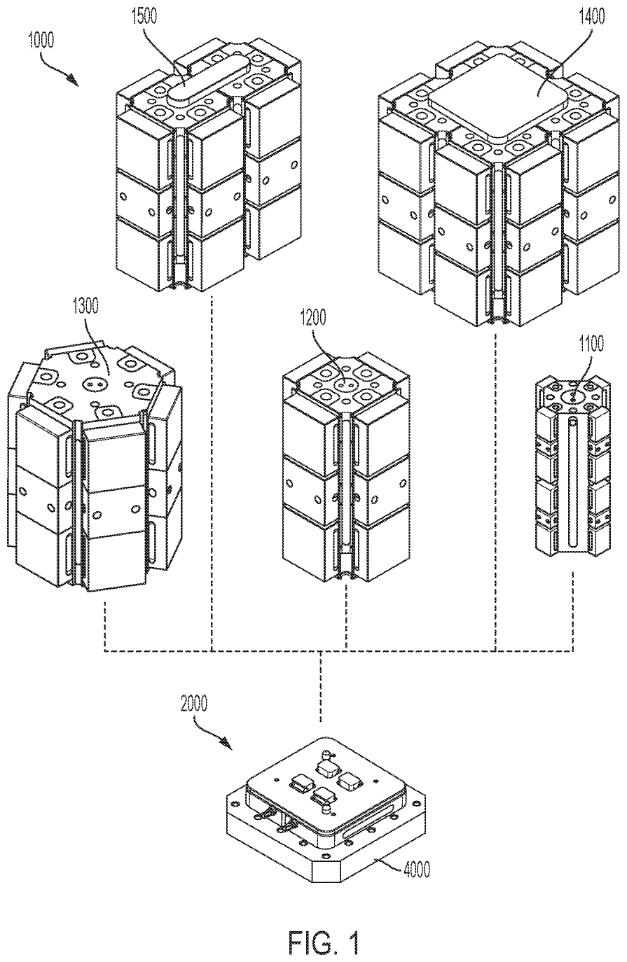

FIG. 1 illustrates a mounting system 1000 in which multiple workpiece holders are compatible with a mount 2000. In at least one aspect, the mount 2000 is attached to a machining platform, such as a milling table, by way of a pallet plate 4000. Exemplary workpiece holders include a four-sided workpiece holder 1100 having two clamping assemblies on each side forming an eight station holder, a four-sided workpiece holder 1200 having one clamping assembly on each side forming a four station holder, a six-sided workpiece holder 1300 having one clamping assembly on each side forming a six station holder, a four-sided workpiece holder 1400 having two clamping assemblies on each side forming an alternative eight station holder, and a four-sided workpiece holder 1500 having two clamping assemblies on two of the sides and one clamping assembly on the other two sides. Alternative workpiece holders are also contemplated. For example, the workpiece holders 1100, 1200, 1300, 1400, and 1500 may include a pair of vertically-stacked clamping assemblies on one or more sides. In various instances, more than two clamp assemblies can be stacked on one or more sides of a workpiece holder. In various instances, the workpiece holder can be a MultiLOK workpiece holder from Chick Workholding Solutions, Warrendale, PA. The system 1000 can also include workpiece holders by other manufacturers, which can be compatible with the mount 2000.

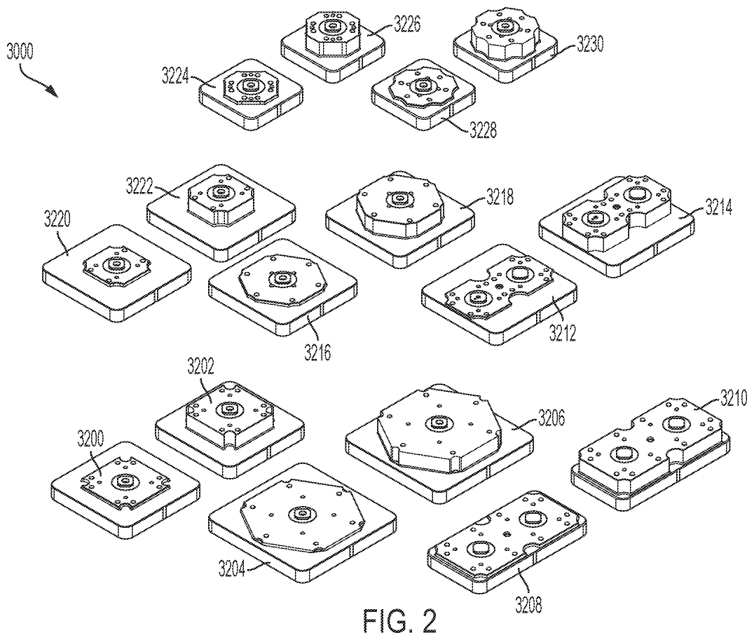

FIG. 2 illustrates a plurality of adapters 3000 of varying sizes and configurations. In various aspects, the adapters 3000 are compatible with one or more of the corresponding workpiece holders and the mount 2000. For example, adapter 3200 and adapter 3202 are compatible with the workpiece holder 1200 illustrated in FIG. 1. Each of the adapters 3000 is shown in a standard height and a raised-height configuration. For example, the adapter 3200 is a standard height adapter and the adapter 3202 is a raised-height adapter. Adapters 3200, 3202, 3204, 3206, 3208, 3210, 3212, 3214, 3216, 3218, 3220, 3222, 3224, 3226, 3228, and 3230 are shown; however, alternative adapters are contemplated. Each adapter is attachable to its respective workpiece holder (e.g. workpiece holders 1100, 1200, 1300, 1400, 1500 in FIG. 1) by way of bolts, screws, and/or any other suitable mechanical fastener.

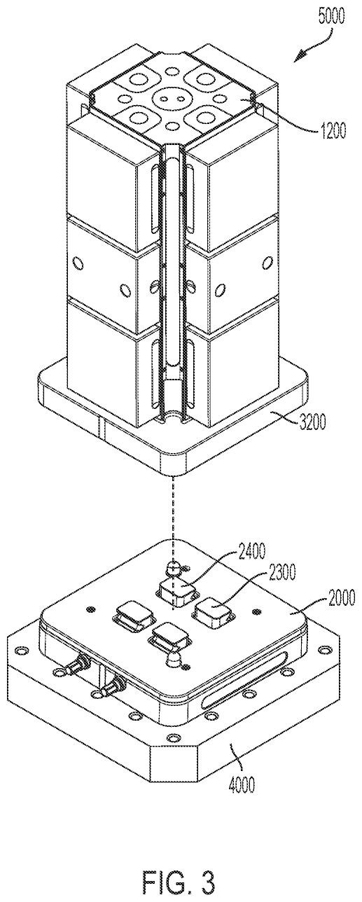

FIG. 3 illustrates the mount 2000 attached to the pallet plate 4000 and also shows the adapter 3200 attached to the workpiece holder 1200 and positioned above the mount 2000. In various aspects, when any one of the adapters 3000 of FIG. 2 is attached to a compatible workpiece holder, the resulting assembly may be referred to as a payload. For example, the adapter 3200 attached to the workpiece holder 1200 forms a payload 5000.

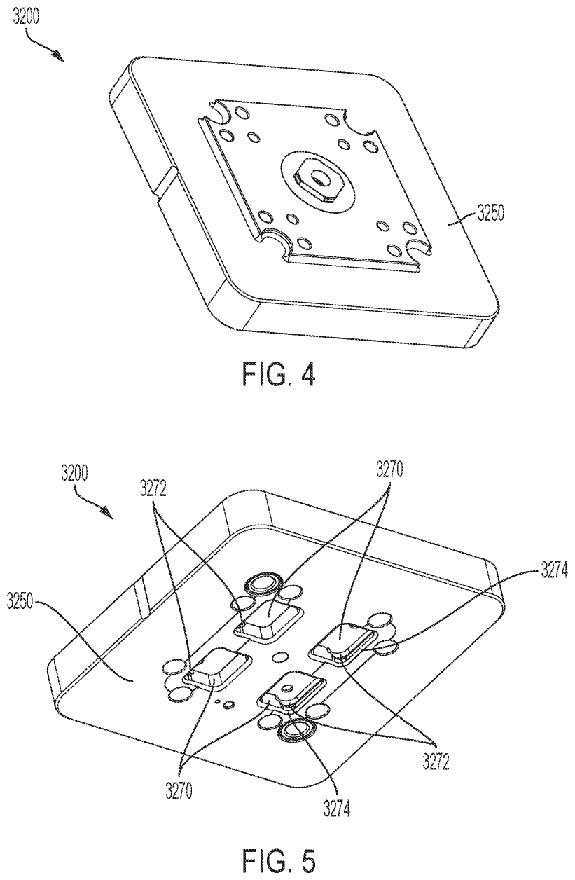

Referring again to FIG. 2, each of adapters 3000 comprises receptacles defined therein, which facilitate attachment of the adapter to the mount 2000. For example, FIGS. 4 and 5 illustrate the adapter 3200 comprising an adapter body 3250 defining a plurality of receptacles 3270. In at least one aspect, the adapter body 3250 defines four receptacles 3270 for receiving four protrusions of the mount 2000, as described in greater detail herein. Further, in at least one aspect, the adapter body 3250 defines a recess 3272 within each receptacle 3270 forming a boss 3274 along the rim of the recess 3272. The recess 3272 is dimensioned and positioned to receive a shoulder of the protrusion positioned therein and the boss 3274 is dimensioned and positioned to retain the shoulder within the recess 3272, as described in greater detail herein.

All of the adapters 3000 illustrated in FIG. 2 comprise receptacles defined therein, similar to the receptacles 3270 (FIG. 5), to facilitate coupling of the adapters 3000 to the mount 2000. In various aspects, an adapter other than those shown in FIG. 2 may be manufactured or otherwise obtained to adapt another type of workpiece holder to be compatible with the mount 2000. In at least one aspect, a workpiece holder may comprise the receptacles 3270 without the need for an adapter plate. In various aspects, any adapter and/or workpiece holder can be compatible with the mount 2000 as long as the adapter/workpiece holder comprises the compatible receptacles (e.g. receptacles 3270) described herein.

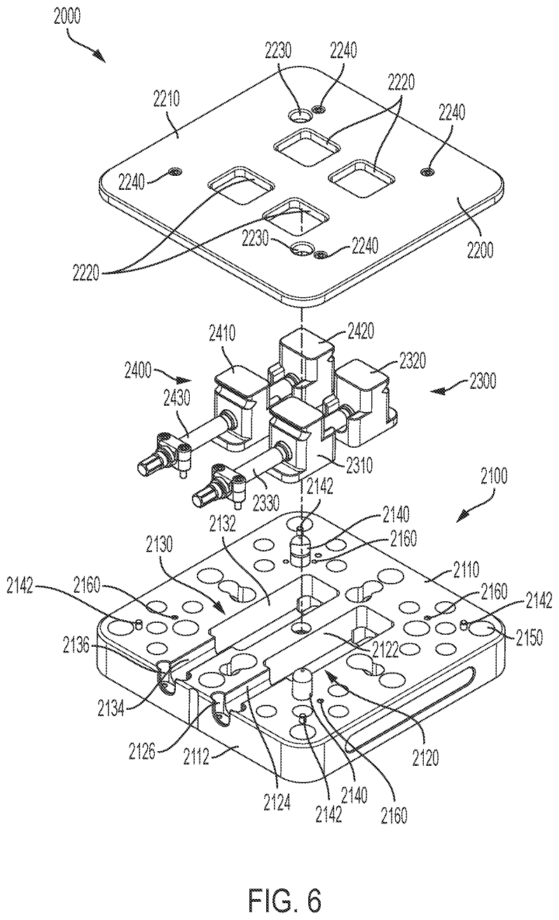

The mount 2000 is depicted in an exploded configuration in FIG. 6 to expose various internal components thereof. The mount 2000 comprises a base 2100, a cover plate 2200, a pair of identical slide assemblies, a first clamp assembly 2300 and a second clamp assembly 2400. Each clamp assembly 2300, 2400 includes a pair of clamps and a protrusion for each clamp that is configured to be received in the receptacles 3270 of one of the adapters 3000, such as the adapter 3200, as described in greater detail below. As further described herein, the mount 2000 is designed such that the base 2100 is first fastened to the machining center or table (e.g. bolted) and the internal components (e.g. clamp assemblies 2300, 2400) are then installed and secured via the cover plate 2200. In such instances, the cover plate 2200 can be removed to access the internal components for service, quality control, and/or maintenance activities without requiring realignment of the base 2100 with the machining center.

Referring still to FIG. 6, the base 2100 comprises a base body 2110 defining a first cavity 2120 and a second cavity 2130. In at least one aspect, the first cavity 2120 and the second cavity 2130 are symmetric about a centerline therebetween and parallel to one another. The first cavity 2120 is to receive the first clamp assembly 2300 and the second cavity 2130 is to receive the second clamp assembly 2400. The first cavity 2120 comprises a first opening 2122, a second opening 2124 connected to the first opening 2122, and a first drive screw mount opening 2126 connected to the second opening 2124. Further, the second cavity 2130 comprises a first opening 2132, a second opening 2134 connected to the first opening 2132, and a second drive screw mount opening 2136 connected to the second opening 2134. In at least one aspect, the first openings 2122, 2132 are wider, i.e., laterally larger, than the second openings 2124, 2134. The drive screw mount openings 2126, 2136 extend through a side 2112 of the base body 2110. Further, the base 2100 further comprises a pair of locating pins 2140 and four reference pins 2142 extending from the base body 2110 for locating and aligning the cover plate 2200 to the base 2100. In various instances, one of the locating pins 2140 can comprise a first perimeter geometry (e.g. a diamond pin), and the other of the locating pins 2140 can comprise a second perimeter geometry (e.g. a round pin). The locating pins 2140 can be dimensioned and positioned to accurate locate the payloads to the base 2100, for example.

In other instances, one or more of the alignment pins and/or reference pins can extend from the cover plate 2200 for mating alignment with geometries on the base 2100. The base 2100 further comprises a plurality of threaded openings 2160 for receiving screws. Once the first clamp assembly 2300 and the second clamp assembly 2400 are installed to the base 2100, the cover plate 2200 can be attached to the base 2100, as described in greater detail below.

Referring still to FIG. 6, the cover plate 2200 comprises a plate body 2210 defining a plurality of apertures 2220, a pair of location pin holes 2230, and four screw holes 2240. The pair of location pin holes 2230 are to receive the pair of locating pins 2140 when the cover plate 2200 is installed onto the base 2100, as shown in FIG. 3. The four reference pins 2142 are to be received in reference pin holes defined on the underside of the plate body 2210. As such, the pair of locating pins 2140 and the four reference pins 2142 properly locate and align the cover plate 2200 with the base 2100. Further, the screw holes 2240 are to align with the threaded openings 2160 when the cover plate 2200 is placed onto the base 2100. Screws can be threaded into the threaded openings 2160 of the base to attach the cover plate 2200 to the base 2100. It should be understood that the cover plate 2200 may be attached to the base 2100 by any suitable mechanical fastening means, such as pins, screws, etc., and combinations thereof. In any event, when the cover plate 2200 is attached to the base 2100 with the clamp assemblies 2300, 2400 installed to the base, the plurality of apertures 2220 of the cover plate 2200 are to receive at least a portion of the clamp assemblies 2300, 2400, as shown in FIG. 3. A portion of each clamp assembly 2300, 2400 extends through respective apertures 2220 and is exposed and accessible outside the cover plate 2200.

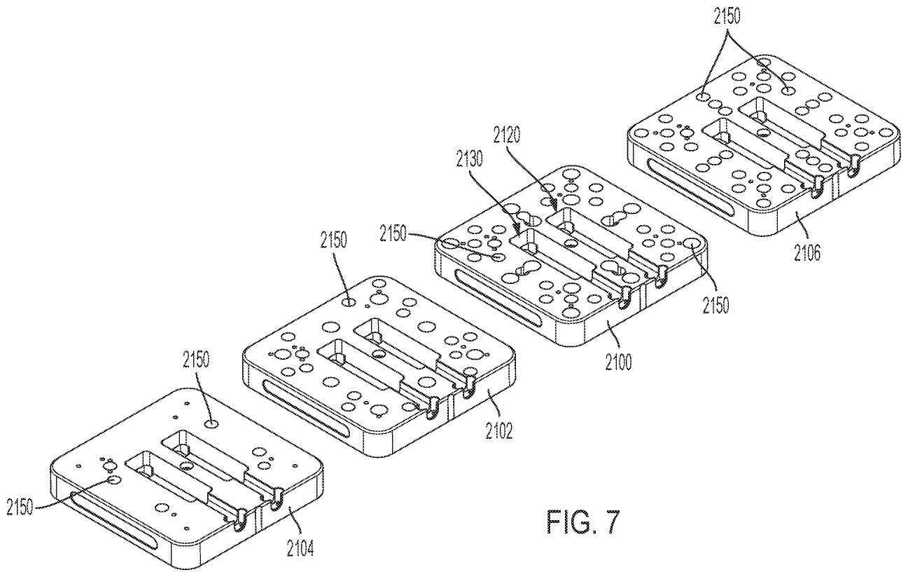

Further to the above, FIG. 7 illustrates different bases 2102, 2104, 2106 and the base 2100 that may be used as a base for the mount 2000. Each of the bases 2102, 2104, 2106 comprises a base body defining a first cavity dimensioned and structured to receive the first clamp assembly 2300, and a second cavity dimensioned and structured to receive the second clamp assembly 2400, similar to the first cavity 2120 and the second cavity 2130 of the base 2100. Each of the bases 2100, 2102, 2104, 2106 defines different amounts and/or patterns of mounting holes 2150 therein for mounting the mount 2000 to different fixture platforms and/or machining tables, in accordance with various aspects of the present disclosure.

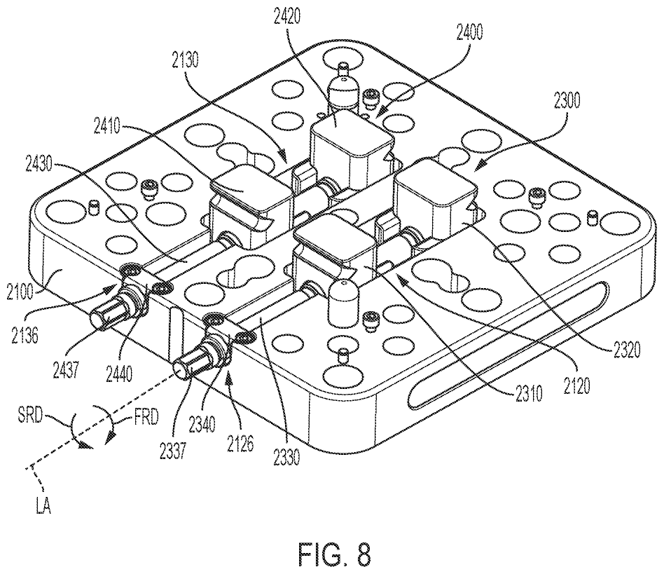

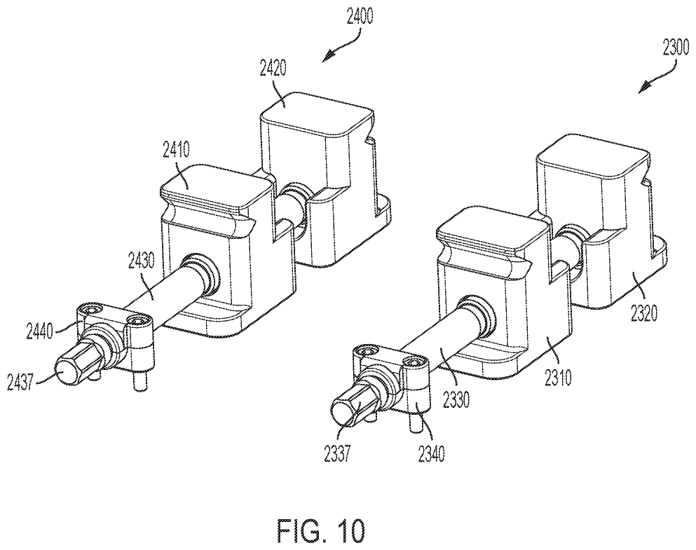

Referring to FIGS. 8-10, the first clamp assembly 2300 comprises a first clamp 2310, a second clamp 2320, a first drive screw 2330, and a first drive screw mount 2340. The first clamp 2310 and the second clamp 2320 are threadably engaged with the first drive screw 2330. To install the first clamp assembly 2300 to the base 2100, the first clamp assembly 2300 is positioned in the first cavity 2120 of the base 2100 and the first drive screw mount 2340 is positioned in the first drive screw mount opening 2126, as shown in FIG. 8. In at least one aspect, the first drive screw mount 2340 is attached to the base 2100 by a pair of screws 2342. In any event, the first drive screw 2330 is rotatably secured to the first drive screw mount 2340 and, thus, when the first clamp assembly 2300 is attached to the base 2100, the first drive screw 2330 is rotatable relative to the base 2100.

Further to the above, the second clamp assembly 2400 comprises a third clamp 2410, a fourth clamp 2420, a second drive screw 2430, and a second drive screw mount 2440. The third clamp 2410 and the fourth clamp 2420 are threadably engaged with the second drive screw 2430. To install the second clamp assembly 2400 to the base 2100, the second clamp assembly 2400 is positioned in the second cavity 2130 of the base 2100 and the second drive screw mount 2440 is positioned in the second drive screw mount opening 2136 as shown in FIG. 8. In at least one aspect, the second drive screw mount 2440 is attached to the base 2100 by a pair of screws 2442. In any event, the second drive screw 2430 is rotatably secured to the second drive screw mount 2440 and, thus, when the second clamp assembly 2400 is attached to the base 2100, the second drive screw 2430 is rotatable relative to the base 2100.

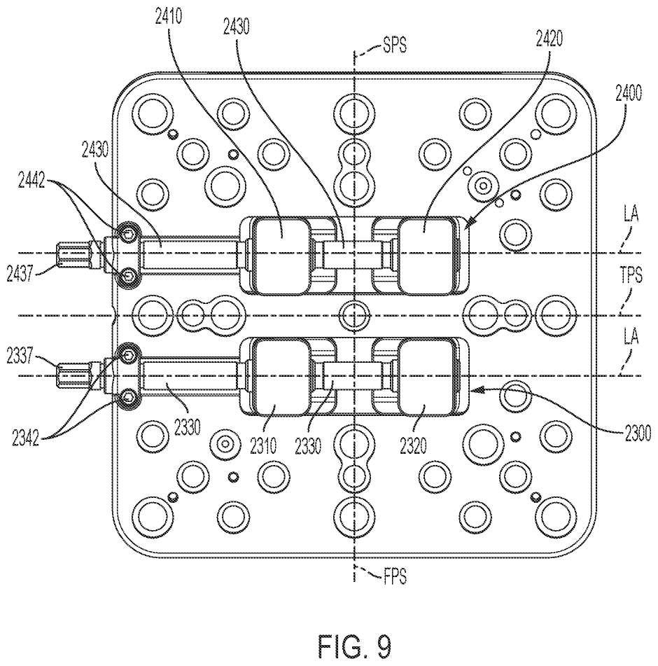

Referring still to FIGS. 8 and 9, the second clamp assembly 2400 is spaced apart from the first clamp assembly 2300 and the first and second drive screws 2330, 2430 extend along parallel longitudinal axes LA (e.g. FIG. 9) through the base 2100. The first clamp assembly 2300 is described in greater detail below. The first and second clamp assemblies 2300, 2400 are identical. For the sake of brevity, the identical components and features of the second clamp assembly 2400 are not repeated herein.

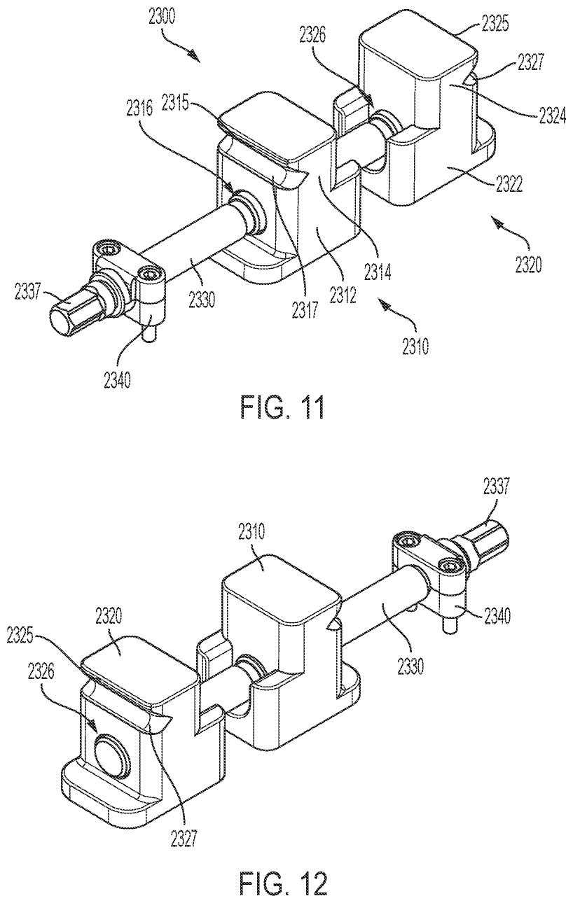

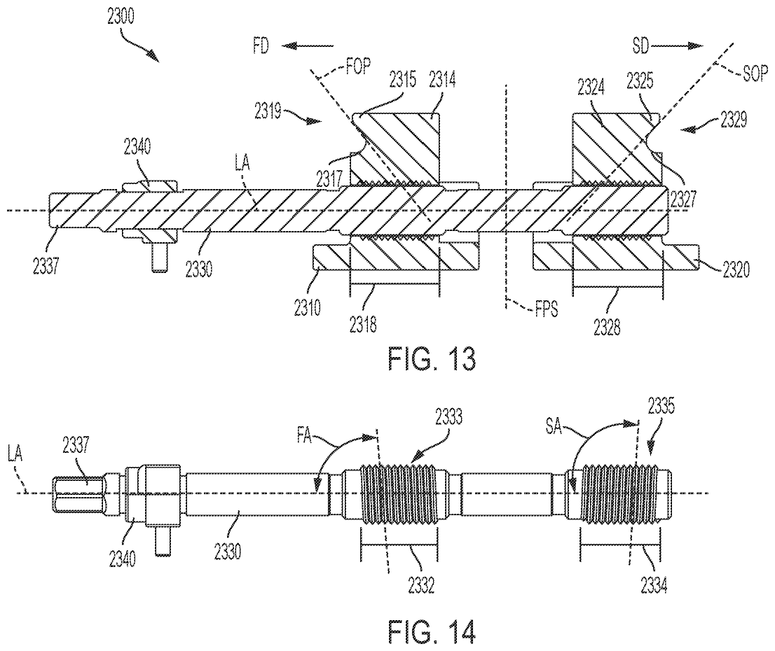

Referring now to FIGS. 11-14, the first clamp assembly 2300 is shown. The first clamp 2310 of the first clamp assembly 2300 comprises a first clamp body 2312 and a first protrusion 2314. The first clamp body 2312 defines a first opening 2316 comprising a first internal threaded length 2318 (see FIG. 13). Further, the first protrusion 2314 comprises a first shoulder 2315 and a first groove 2317 positioned underneath the first shoulder 2315. In at least one aspect, the first shoulder 2315 and the first groove 2317 define a first hook 2319.

Further to the above, the second clamp 2320 of the first clamp assembly 2300 comprises a second clamp body 2322 and a second protrusion 2324. The second clamp body 2322 defines a second opening 2326 comprising a second internal threaded length 2328 (see FIG. 13). Further, the second protrusion 2324 comprises a second shoulder 2325 and a second groove 2327 positioned underneath the second shoulder 2325. In at least one aspect, the second shoulder 2325 and the second groove 2327 define a second hook 2329. In at least one aspect, the first shoulder 2315 and the second shoulder 2325 face opposite directions. In at least one aspect, the first shoulder 2315 and the second shoulder 2325 face away from each other.

Referring to FIGS. 13 and 14, the first drive screw 2330 of the first clamp assembly 2300 defines a longitudinal axis LA. The first drive screw 2330 comprises a first external threaded length 2332 threadably engaged with the first internal threaded length 2318 of the first clamp 2310. The first external threaded length 2332 comprises a plurality of first threads 2333. Further, the first drive screw 2330 comprises a second external threaded length 2334 threadably engaged with the second internal threaded length 2328 of the second clamp 2320. The second external threaded length 2334 comprises a plurality of second threads 2335. In at least one aspect, the second threads 2335 are oriented in the opposite direction of the first threads 2333 such that a rotation of the first drive screw 2330 moves the first clamp 2310 and the second clamp 2320 in opposite directions along the longitudinal axis LA.

Further to the above, in at least one aspect, the first threads 2333 are right-hand threads and the second threads 2335 are left-hand threads. In at least one aspect, the first threads 2333 are left-hand threads and the second threads 2335 are right-hand threads. Further, in at least one aspect, the first drive screw 2330 defines the first threads 2333 at a first angle FA relative to the longitudinal axis LA and defines the second threads 2335 at a second angle SA relative to the longitudinal axis LA. In at least one aspect, the first angle FA is an acute angle and the second angle SA is an obtuse angle as shown in FIG. 14. In various instances, the first angle FA and the second angle SA can be supplementary angles, for example.

Further to the above, in at least one aspect, the first clamp 2310 and the second clamp 2320 are symmetrical about a first plane of symmetry FPS (see FIG. 13) positioned intermediate the first clamp 2310 and the second clamp 2320. In at least one aspect, the first clamp 2310 and the second clamp 2320 are identical to one another with the first shoulder 2315 of the first clamp 2310 facing a first direction FD and the second shoulder 2325 of the second clamp 2320 facing a second direction SD that is opposite the first direction FD, see FIG. 13. In at least one aspect, the first plane of symmetry FPS is orthogonal to the longitudinal axis LA of the first drive screw 2330.

Further to the above, in at least one aspect, the first shoulder 2315 defines a first oblique plane FOP transecting the longitudinal axis LA and the second shoulder defines a second oblique plane SOP transecting the longitudinal axis LA. In at least one aspect, the first oblique plane FOB and the second oblique plane SOB are mirrored about the first plane of symmetry FPS. As described in greater detail below, the first clamp 2310 and the second clamp 2320 are configured to move simultaneously relative to one another, relative to the first drive screw 2330, and relative to the first plane of symmetry FPS upon rotation of the first drive screw 2330.

In at least one aspect, when the first clamp assembly 2300 is installed to the base 2100, as shown in FIG. 8 and as described above, a first rotation of the first drive screw 2330 in a first rotational direction FRD (see FIG. 8) will cause the first clamp 2310 and the second clamp 2320 to move away from each other. The opposing movement of the clamps 2310, 2320 is in part due to the first threads 2333 and the second threads 2335 of the first drive screw 2330 being threaded in opposite directions. Moreover, the first clamp 2310 and the second clamp 2320 are rotatably constrained within the first cavity 2120 of the base 2100 such that when the first drive screw 2330 is rotated in the first rotational direction FRD, the first clamp 2310 and the second clamp 2320 are translated away from each other along the longitudinal axis LA.

Further to the above, in at least one aspect, when the first clamp assembly 2300 is installed to the base 2100, as shown in FIG. 8 and as described above, a second rotation of the first drive screw 2330 in a second rotational direction SRD that is opposite the first rotational direction FRD will cause the first clamp 2310 and the second clamp 2320 to move toward each other. As discussed above, the opposite threads and rotatably constrained clamps 2310, 2320 permit the first clamp 2310 and the second clamp 2320 to translate toward each other along the longitudinal axis LA when the first drive screw 2330 is rotated in the second rotational direction SRD. In at least one aspect, no matter the direction or magnitude of rotation of the first drive screw 2330, the first clamp 2310 and the second clamp 2320 are equidistantly spaced from the first plane of symmetry FPS. Further, in at least one aspect, the first shoulder 2315 and the second shoulder 2325 move away from each other when the first drive screw 2330 is rotated in the first rotational direction FRD and move toward each other when the first drive screw 2330 is rotated in the second rotational direction SRD.

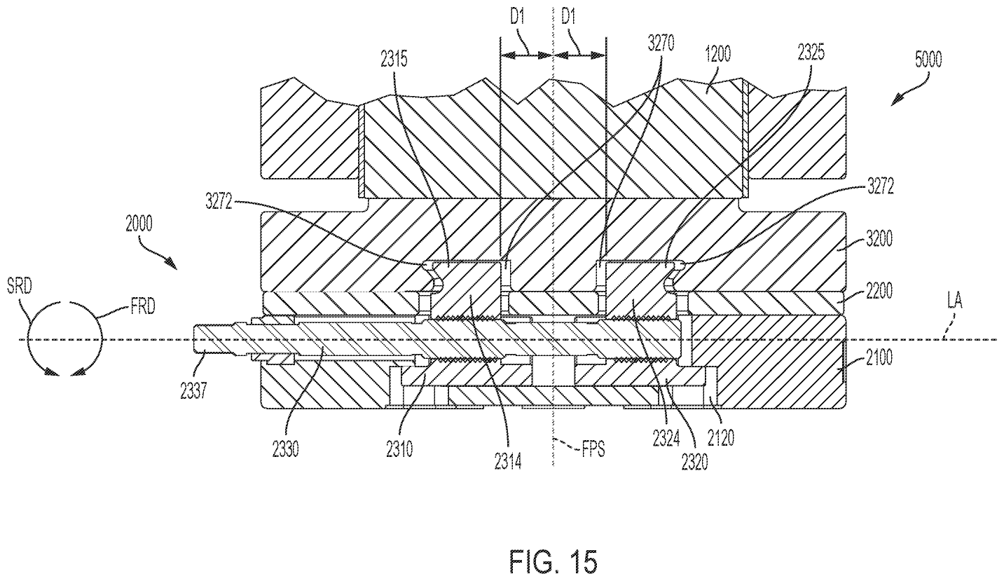

FIG. 15 illustrates a portion of the payload 5000 (e.g., the adapter 3200 and a portion of the workpiece holder 1200) positioned onto the mount 2000 with the protrusions 2314, 2324 of the first and second clamps 2310, 2320 received within the receptacles 3270 of the adapter 3200. In at least one aspect, the first clamp 2310 and the second clamp 2320 are positioned the same first distance D1 from the first plane of symmetry FPS. Further, the first clamp 2310 and the second clamp 2320 are in a first configuration when they are positioned the first distance D1 from the first plane of symmetry FPS. In at least one aspect, the first configuration of the clamps 2310, 2320 facilitates placement of the payload 5000 onto the mount 2000 by providing clearance for the protrusions 2314, 2324 to enter the receptacles 3270.

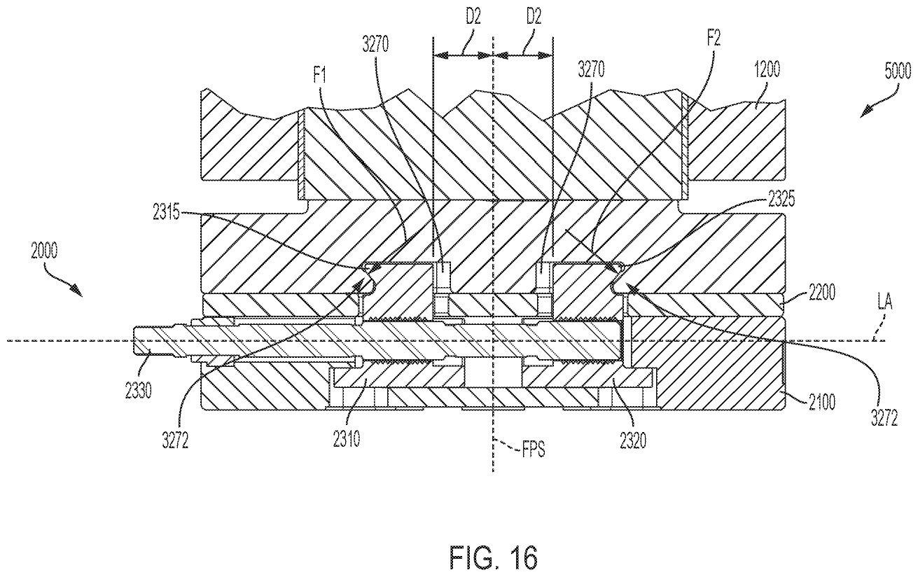

In use, upon rotation of the first drive screw 2330 in the first rotational direction FRD, the first clamp 2310 and the second clamp 2320 move away from the first configuration shown in FIG. 15 and move away from each other to a second configuration shown in FIG. 16. As the first clamp 2310 and the second clamp 2320 move from the first configuration to the second configuration, the first shoulder 2315 and the second shoulder 2325 engage the corresponding recesses 3272 of the receptacles 3270 of the adapter 3200, as shown in FIG. 16. More specifically, the first hook 2319 is structured to hook around the boss 3274 and extend into the recess 2372 of one of the receptacles 3270 to secure the first clamp 2310 to the adapter 3200/workpiece 1200, and the second hook 2329 is structured to hook around the boss 3274 and extend into the recess 3272 of another receptacle 3270 to clamp or lock the second claim 2320 to the adapter 3200/workpiece 1200. Further, the first clamp 2310 and the second clamp 2320 are positioned the same second distance D2 from the first plane of symmetry FPS when the first clamp 2310 and the second clamp 2320 are in the second configuration, see FIG. 16. As discussed above, no matter the direction or magnitude of rotation of the first drive screw 2330, the first clamp 2310 and the second clamp 2320 are equidistantly spaced from the first plane of symmetry FPS.

Referring to FIG. 16, when first clamp 2310 and the second clamp 2320 are in the second configuration, the first clamp 2310 applies a first force F1 to the receptacle 3270 of the adapter 3200 and the second clamp 2320 applies a second force F2 to the receptacle 3270 of the adapter 3200. In at least one aspect, the first force F1 and the second force F2 are equal and opposite. In at least one aspect, the first force F1 is orthogonal to the first oblique plane FOB (see FIG. 13) and the second force F2 is orthogonal to the second oblique plane (see FIG. 13). In at least one aspect, the forces F1 and F2 are applied at an angle relative to the first plane of symmetry FPS. As such, the applied forces F1 and F2 each have an outward component and a downward component and thus, the clamps 2310, 2320 press outward on and pull downward on the adapter 3200 to retain the payload 5000 to the mount 2000.

Referring to FIGS. 8 and 9, both of the first clamp assembly 2300 and the second clamp assembly 2400 are shown installed to the base 2100, as described above. The first drive screw 2330 of the first clamp assembly 2300 comprises a grip 2337 (e.g., a hex head) defined at an end thereof. The grip 2337 is rotatable by a user with a tool (e.g., a socket) to rotate the first drive screw 2330 relative to the base 2100 of the mount 2000. Similarly, the second drive screw 2430 of the second clamp assembly 2400 comprises a grip 2437 (e.g., a hex head) defined at an end thereof. The grip 2437 is rotatable by a user with a tool (e.g., a socket) to rotate the second drive screw 2430 relative to the base 2100 of the mount 2000. The first drive screw 2330 and the second drive screw 2430 are separately actuatable. In at least one aspect the first drive screw 2330 and the second drive screw 2430 can be actuated simultaneously.

Referring still to FIGS. 8 and 9, in at least one aspect, the third clamp 2410 and the fourth clamp 2420 of the second clamp assembly 2400 are symmetrical about a second plane of symmetry SPS (see FIG. 9). In at least one aspect, when the first clamp assembly 2300 and the second clamp assembly 2400 are installed to the base 2100, the first plane of symmetry FPS and the second plane of symmetry SPS are aligned. In other words, the first plane of symmetry FPS and the second plane of symmetry SPS are co-planar. Further, in at least one aspect, the first clamp assembly 2300 and the second clamp assembly 2400 are symmetrical about a third plane of symmetry TPS, see FIG. 9. In at least one aspect, when the clamp assemblies 2300, 2400 are installed to the base 2100, the third plane of symmetry TPS is parallel to the longitudinal axis LA of the first drive screw 2330 and the longitudinal axis LA of the second drive screw 2430. Moreover, in at least one aspect, the first plane of symmetry FPS and the second plane of symmetry SPS are orthogonal to the third plane of symmetry TPS.

Further to the above, it should be understood that, in various aspects, the second clamp assembly 2400 is identical structurally and functionally to the first clamp assembly 2300 such that the third clamp 2410 and the fourth clamp 2420 of the second clamp assembly 2300 (see FIG. 8) engage respective receptacles 3270 of the adapter 3200 in the same manner as the first clamp 2310 and the second clamp 2320 of the first clamp assembly 2300, as described above.

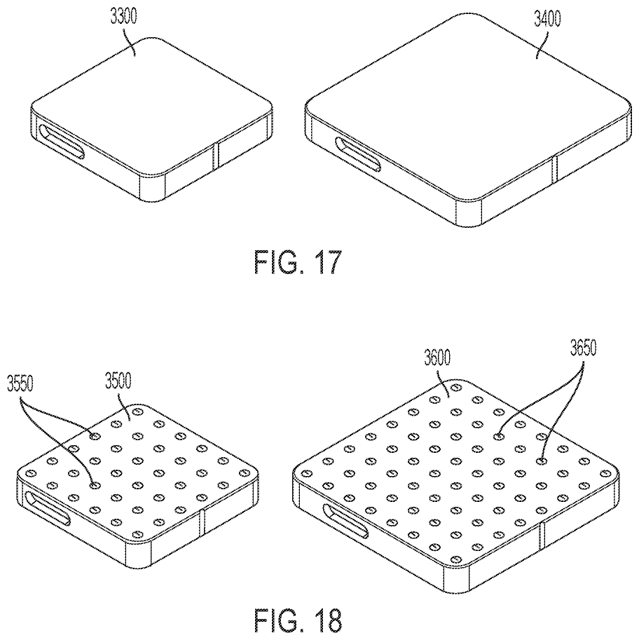

As discussed above, the mount 2000 can be attached to a workpiece holder, by way of an adapter, such as the adapters shown in FIG. 2. Further, FIG. 17 illustrates adapters 3300, 3400 that are blank to allow customization. For example, any hole/aperture pattern could be made in the adapters 3300, 3400 to facilitate attachment of adapters 3300, 3400 to various types of workpiece holders and/or to facilitate attachment of the mount 2000 to the workpiece holders. Further, FIG. 18 illustrates adapters 3500 and 3600 having holes 3550, 3650 defined therein to facilitate attachment of the adapters 3500, 3600 to a workpiece holder and/or to facilitate attachment of the mount 2000 to the adapters 3500, 3600, for example. In various aspects, the adapters 3300, 3400, 3500, 3600 can be customized to comprise the receptacles (e.g. receptacles 3270) described herein to facilitate compatibility with the mount 2000.

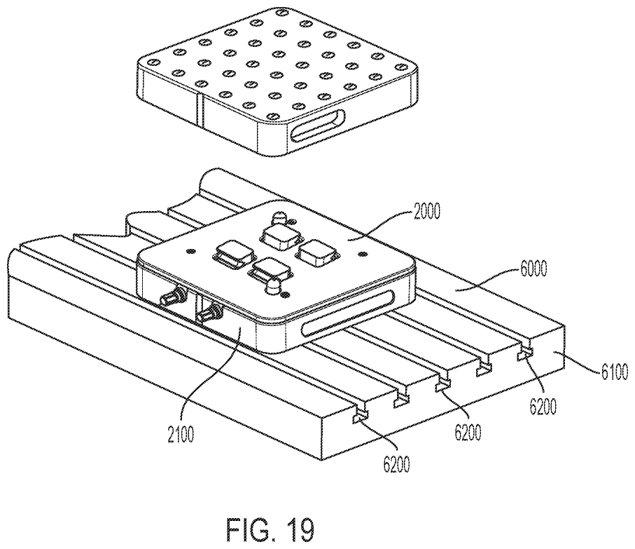

As discussed herein, the mount 2000 is compatible with various types of machining platforms and may or may not require a pallet plate, such as the pallet plate 4000, to be attached to a machining platform. For example, For example, FIG. 19 illustrates the mount 2000 attached to a T-slotted machining platform 6000. The machining platform 6000 comprises a body portion 6100 defining a plurality of longitudinal T-slots 6200. Fasteners such as screws, bolts, etc., and combinations thereof, may be utilized to attach the base 2100 of the mount 2000 directly to the T-slotted machining table 6000. The machining platform 6000 can be oriented horizontally or vertically. For example, a T-slotted machining platform is typical for various vertical machining centers.

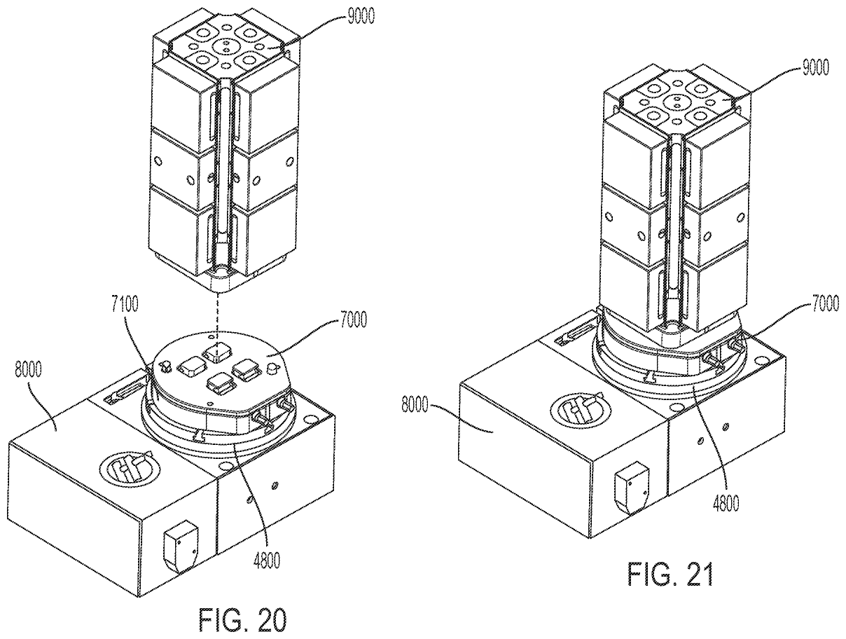

Further to the above, FIG. 20 illustrates a mount 7000 similar to the mount 2000 except for the difference described herein. The mount 7000 comprises a base 7100 having a partially circular or arcuate perimeter. The base 7100 may be similar to the base 2100. For example, in at least one aspect, the base 7100 comprise the first cavity 2120 and the second cavity 2130 of the base 2100 (see FIG. 6) for receiving the first clamp assembly 2300 and the second clamp assemblies 2400, respectively. In any event, the base 7100 is mounted to a pallet plate 4800 that is mechanically attached to an indexer, or 4-axis machining table, 8000. Once the base 7100 is attached to the pallet plate 4800, a workpiece holder 9000 can be mounted to the mount 7000, as described herein in relation to the mount 2000. In at least one aspect, the workpiece holder 9000 must first be outfitted with an adapter, such as one of the adapters 3000 shown in FIG. 2, in order to be mounted to the mount 7000. In at least one aspect, the workpiece holder 9000 comprises receptacles defined directly into the bottom of the workpiece holder 9000 to facilitate mounting of the workpiece holder 9000 onto the mount 7000 without a separate adapter component. In at least one aspect, the receptacles defined directly into the workpiece holder 9000 may be similar to the receptacles 3270 of the adapter 3200.

The reader will appreciate that the various mounts disclosed herein can be utilized with horizontal and vertical machining centers and with or without indexers, for example. The mounts disclosed herein facilitate a quick-mount capability with sufficient force to securely hold a payload on the various machining centers. Upon installation of the mounts disclosed herein onto a machining table, a variety of workpiece holders can be quickly, rigidly, and accurately mounted and dismounted to the machining table via the mount.

Various aspects of the subject matter described herein are set out in the following numbered examples.

Example 1—A mount for a machining platform, the mount comprising a body, a first clamp movable relative to the body, a second clamp movable relative to the body, and a drive screw rotatably mounted to the body. The first clamp comprises a first clamp body defining a first opening comprising a first internal threaded length. The first clamp further comprises a first protrusion comprising a first shoulder. The second clamp comprises a second clamp body defining a second opening comprising a second internal threaded length. The second clamp further comprises a second protrusion comprising a second shoulder. The drive screw comprises a first external threaded length threadably engaged with the first internal threaded length of the first clamp. The first external threaded length comprises first threads. The drive screw further comprises a second external threaded length threadably engaged with the second internal threaded length of the second clamp. The second external threaded length comprises second threads oriented in the opposite direction of the first threads. The first shoulder and the second shoulder move away from each other upon a rotation of the drive screw.

Example 2—The mount of Example 1, wherein the first external threaded length is right-handed, and wherein the second external threaded length is left-handed.

Example 3—The mount of Example 1 or 2, wherein the first shoulder and the second shoulder face opposite directions.

Example 4—The mount of Examples 1, 2, or 3, wherein the first clamp and the second clamp are equidistantly spaced from a plane of symmetry positioned intermediate the first clamp and the second clamp.

Example 5—The mount of Example 4, wherein the first clamp and the second clamp are symmetrical about the plane of symmetry.

Example 6—The mount of Example 4 or 5, wherein the drive screw defines a longitudinal axis, wherein the first shoulder defines a first oblique plane transecting the longitudinal axis, wherein the second shoulder defines a second oblique plane transecting the longitudinal axis, and wherein the first oblique plane and the second oblique plane are mirrored about the plane of symmetry.

Example 7—The mount of Examples 1, 2, 3, 4, 5, or 6, wherein the first protrusion further comprises a first groove, and wherein the first shoulder and the first groove define a hook.

Example 8—The mount of Examples 1, 2, 3, 4, 5, 6, or 7, wherein the body comprises a cover plate, and wherein the first protrusion and the second protrusion extend through the cover plate.

Example 9—The mount of Examples 1, 2, 3, 4, 5, 6, 7, or 8, wherein the drive screw comprises a first drive screw, wherein the mount further comprises a third clamp movable relative to the body, a fourth clamp movable relative to the body, and a second drive screw rotatably mounted to the body. The third clamp comprises a third clamp body defining a third opening comprising a third internal threaded length. The third clamp further comprises a third protrusion comprising a third shoulder. The fourth clamp comprises a fourth clamp body defining a fourth opening comprising a fourth internal threaded length. The fourth clamp further comprises a fourth protrusion comprising a fourth shoulder. The second drive screw is parallel to the first drive screw. The second drive screw comprises a third external threaded length threadably engaged with the third internal threaded length of the third clamp. The second drive screw further comprises a fourth external threaded length threadably engaged with the fourth internal threaded length of the fourth clamp. The fourth external threaded length is in the opposite direction of the third external threaded length. The third shoulder and the fourth shoulder move away from each other upon a rotation of the second drive screw.

Example 10—A mount for a machining platform, the mount comprising a body, a first clamp movable relative to the body, a second clamp movable relative to the body, and a drive screw rotatably mounted to the body. The first clamp comprises a first clamp body defining a first threaded opening. The first clamp further comprises a first protrusion comprising a first shoulder. The second clamp comprises a second clamp body defining a second threaded opening. The second clamp further comprises a second protrusion comprising a second shoulder. The first shoulder and the second shoulder face away from each other. The drive screw comprises a plurality of first external right-hand threads threadably engaged with the first threaded opening of the first clamp. The drive screw further comprises a plurality of second external left-hand threads threadably engaged with the second threaded opening of the second clamp. The first shoulder and the second shoulder simultaneously move away from each other upon a rotation of the drive screw.

Example 11—The mount of Example 10, wherein a plane of symmetry is defined between the first clamp and the second clamp, wherein the drive screw defines a longitudinal axis orthogonal to the plane of symmetry, wherein the first clamp and the second clamp are equidistantly spaced from the plane of symmetry.

Example 12—The mount of Example 11, wherein the first shoulder defines a first oblique plane transecting the longitudinal axis, wherein the second shoulder defines a second oblique plane transecting the longitudinal axis, and wherein the first oblique plane and the second oblique plane are mirrored about the plane of symmetry.

Example 13—The mount of Examples 10, 11, or 12, wherein the first protrusion comprises a first groove, and wherein the first shoulder and the first groove define a hook.

Example 14—The mount of Examples 10, 11, 12, or 13, wherein the body comprises a cover plate, and wherein the first protrusion and the second protrusion extend through the cover plate.

Example 15—The mount of Examples 10, 11, 12, 13, or 14, wherein the drive screw comprises a first drive screw, and wherein the mount further comprises a third clamp movable relative to the body, a fourth clamp movable relative to the body, and a second drive screw rotatably mounted to the body. The third clamp comprises a third clamp body defining a third threaded opening. The third clamp further comprises a third protrusion comprising a third shoulder. The fourth clamp comprises a fourth clamp body defining a fourth threaded opening. The fourth clamp further comprises a fourth protrusion comprising a fourth shoulder. The third shoulder and the fourth shoulder face away from each other. The second drive screw is parallel to the first drive screw. The second drive screw comprises a plurality of third external right-hand threads threadably engaged with the third threaded opening of the third clamp. The second drive screw further comprises a plurality of fourth external left-hand threads threadably engaged with the fourth threaded opening of the fourth clamp. The third shoulder and the fourth shoulder simultaneously move away from each other upon a rotation of the second drive screw.

Example 16—A mounting system, comprising a body, a first clamp movable relative to the body, a second clamp movable relative to the body, and a drive screw rotatably mounted to the body. The first clamp comprises a first clamp body defining a first threaded opening. The first clamp further comprises a first protrusion comprising a first shoulder. The second clamp comprises a second clamp body defining a second threaded opening. The second clamp further comprises a second protrusion comprising a second shoulder. The first shoulder and the second shoulder face away from each other. A plane of symmetry is defined between the first clamp and the second clamp. The drive screw comprises a plurality of first external threads threadably engaged with the first threaded opening of the first clamp. The drive screw further comprises a plurality of second external threads threadably engaged with the second threaded opening of the second clamp. The first shoulder and the second shoulder move from a first configuration to a second configuration upon a rotation of the drive screw. The first clamp and the second clamp are equidistantly spaced from the plane of symmetry in the first configuration and in the second configuration.

Example 17—The mounting system of Example 16, wherein the first protrusion comprises a first groove, and wherein the first shoulder and the first groove define a hook.

Example 18—The mounting system of Example 16 or 17, wherein the drive screw comprises a first drive screw and the plane of symmetry comprises a first plane of symmetry, and wherein the mounting system further comprises a third clamp movable relative to the body, a fourth clamp movable relative to the body, and a second drive screw rotatably mounted to the body. The third clamp comprises a third clamp body defining a third threaded opening. The third clamp further comprises a third protrusion comprising a third shoulder. The fourth clamp comprises a fourth clamp body defining a fourth threaded opening. The fourth clamp further comprises a fourth protrusion comprising a fourth shoulder. The third shoulder and the fourth shoulder face away from each other. A second plane of symmetry is defined between the third clamp and the fourth clamp. The second drive screw is parallel to the first drive screw. The second drive screw comprises a plurality of third external threads threadably engaged with the third threaded opening of the third clamp. The second drive screw comprises a plurality of fourth external threads threadably engaged with the fourth threaded opening of the fourth clamp. The third shoulder and the fourth shoulder move from a third configuration to a fourth configuration upon a rotation of the second drive screw. The third clamp and the fourth clamp are equidistantly spaced from the second plane of symmetry in the third configuration and in the fourth configuration.

Example 19—The mounting system of Example 18, wherein the mounting system further comprises a payload, wherein the first clamp and the second clamp are positioned to exert equal and opposite clamping forces on the payload in the second configuration, and wherein the third clamp and the fourth clamp are positioned to exert equal and opposite clamping forces on the payload in the fourth configuration.

Example 20—The mounting system of Example 18 or 19, wherein a third plane of symmetry is defined between the first clamp and the third clamp such that the first clamp and the third clamp are equidistantly spaced from the third plane of symmetry, and wherein the first drive screw and the second drive screw extend longitudinally on opposite sides of the third plane of symmetry.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

As used in any aspect herein, the terms “component,” “system,” “module” and the like can refer to a computer-related entity, either hardware, a combination of hardware and software, software, or software in execution.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

It will be further appreciated that, for convenience and clarity, spatial terms such as “vertical”, “horizontal”, “up”, and “down” may be used herein with respect to the drawings. However, treatment systems can be used in many orientations and positions, and these terms are not intended to be limiting and/or absolute.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A mount for a machining platform, the mount comprising:
a body;
a first clamp movable relative to the body, the first clamp comprising:
a first clamp body defining a first opening comprising a first internal threaded length; and
a first protrusion comprising a first shoulder;
a second clamp movable relative to the body, the second clamp comprising:
a second clamp body defining a second opening comprising a second internal threaded length; and
a second protrusion comprising a second shoulder; and
a drive screw rotatably mounted to the body, the drive screw comprising:
a first external threaded length threadably engaged with the first internal threaded length of the first clamp, wherein the first external threaded length comprises first threads; and
a second external threaded length threadably engaged with the second internal threaded length of the second clamp, wherein the second external threaded length comprises second threads oriented in the opposite direction of the first threads, and wherein the first shoulder and the second shoulder move away from each other upon a rotation of the drive screw.

2. The mount of claim 1, wherein the first external threaded length is right-handed, and wherein the second external threaded length is left-handed.

3. The mount of claim 1, wherein the first shoulder and the second shoulder face opposite directions.

4. The mount of claim 1, wherein the first clamp and the second clamp are equidistantly spaced from a plane of symmetry positioned intermediate the first clamp and the second clamp.

5. The mount of claim 4, wherein the first clamp and the second clamp are symmetrical about the plane of symmetry.

6. The mount of claim 5, wherein the drive screw defines a longitudinal axis, wherein the first shoulder defines a first oblique plane transecting the longitudinal axis, wherein the second shoulder defines a second oblique plane transecting the longitudinal axis, and wherein the first oblique plane and the second oblique plane are mirrored about the plane of symmetry.

7. The mount of claim 1, wherein the first protrusion further comprises a first groove, and wherein the first shoulder and the first groove define a hook.

8. The mount of claim 1, wherein the body comprises a cover plate, and wherein the first protrusion and the second protrusion extend through the cover plate.

9. The mount of claim 1, wherein the drive screw comprises a first drive screw, wherein the mount further comprises:
a third clamp movable relative to the body, the third clamp comprising:
a third clamp body defining a third opening comprising a third internal threaded length; and
a third protrusion comprising a third shoulder;
a fourth clamp movable relative to the body, the fourth clamp comprising:
a fourth clamp body defining a fourth opening comprising a fourth internal threaded length; and
a fourth protrusion comprising a fourth shoulder; and
a second drive screw rotatably mounted to the body, wherein the second drive screw is parallel to the first drive screw, the second drive screw comprising:
a third external threaded length threadably engaged with the third internal threaded length of the third clamp; and
a fourth external threaded length threadably engaged with the fourth internal threaded length of the fourth clamp, wherein the fourth external threaded length is in the opposite direction of the third external threaded length, and wherein the third shoulder and the fourth shoulder move away from each other upon a rotation of the second drive screw.

10. A mount for a machining platform, the mount comprising:
a body;
a first clamp movable relative to the body, the first clamp comprising:
a first clamp body defining a first threaded opening; and
a first protrusion comprising a first shoulder;
a second clamp movable relative to the body, the second clamp comprising:
a second clamp body defining a second threaded opening; and
a second protrusion comprising a second shoulder, wherein the first shoulder and the second shoulder face away from each other; and
a drive screw rotatably mounted to the body, the drive screw comprising:
a plurality of first external right-hand threads threadably engaged with the first threaded opening of the first clamp; and
a plurality of second external left-hand threads threadably engaged with the second threaded opening of the second clamp, wherein the first shoulder and the second shoulder simultaneously move away from each other upon a rotation of the drive screw.

11. The mount of claim 10, wherein a plane of symmetry is defined between the first clamp and the second clamp, wherein the drive screw defines a longitudinal axis orthogonal to the plane of symmetry, wherein the first clamp and the second clamp are equidistantly spaced from the plane of symmetry.

12. The mount of claim 11, wherein the first shoulder defines a first oblique plane transecting the longitudinal axis, wherein the second shoulder defines a second oblique plane transecting the longitudinal axis, and wherein the first oblique plane and the second oblique plane are mirrored about the plane of symmetry.

13. The mount of claim 10, wherein the first protrusion comprises a first groove, and wherein the first shoulder and the first groove define a hook.

14. The mount of claim 10, wherein the body comprises a cover plate, and wherein the first protrusion and the second protrusion extend through the cover plate.

15. The mount of claim 10, wherein the drive screw comprises a first drive screw, and wherein the mount further comprises:
a third clamp movable relative to the body, the third clamp comprising:
a third clamp body defining a third threaded opening; and
a third protrusion comprising a third shoulder;
a fourth clamp movable relative to the body, the fourth clamp comprising:
a fourth clamp body defining a fourth threaded opening;
a fourth protrusion comprising a fourth shoulder, wherein the third shoulder and the fourth shoulder face away from each other; and
a second drive screw rotatably mounted to the body, wherein the second drive screw is parallel to the first drive screw, the second drive screw comprising:
a plurality of third external right-hand threads threadably engaged with the third threaded opening of the third clamp; and
a plurality of fourth external left-hand threads threadably engaged with the fourth threaded opening of the fourth clamp, wherein the third shoulder and the fourth shoulder simultaneously move away from each other upon a rotation of the second drive screw.

16. A mounting system, comprising:
a body;
a first clamp movable relative to the body, the first clamp comprising:
a first clamp body defining a first threaded opening; and
a first protrusion comprising a first shoulder;
a second clamp movable relative to the body, the second clamp comprising:
a second clamp body defining a second threaded opening; and
a second protrusion comprising a second shoulder, wherein the first shoulder and the second shoulder face away from each other, wherein a plane of symmetry is defined between the first clamp and the second clamp; and
a drive screw rotatably mounted to the body, the drive screw comprising:
a plurality of first external threads threadably engaged with the first threaded opening of the first clamp; and
a plurality of second external threads threadably engaged with the second threaded opening of the second clamp, wherein the first shoulder and the second shoulder move from a first configuration to a second configuration upon a rotation of the drive screw, and wherein the first clamp and the second clamp are equidistantly spaced from the plane of symmetry in the first configuration and in the second configuration.

17. The mounting system of claim 16, wherein the first protrusion comprises a first groove, and wherein the first shoulder and the first groove define a hook.

18. The mounting system of claim 16, wherein the drive screw comprises a first drive screw and the plane of symmetry comprises a first plane of symmetry, and wherein the mounting system further comprises:
a third clamp movable relative to the body, the third clamp comprising:
a third clamp body defining a third threaded opening; and
a third protrusion comprising a third shoulder;
a fourth clamp movable relative to the body, the fourth clamp comprising:
a fourth clamp body defining a fourth threaded opening; and
a fourth protrusion comprising a fourth shoulder, wherein the third shoulder and the fourth shoulder face away from each other, wherein a second plane of symmetry is defined between the third clamp and the fourth clamp; and
a second drive screw rotatably mounted to the body, wherein the second drive screw is parallel to the first drive screw, the second drive screw comprising:
a plurality of third external threads threadably engaged with the third threaded opening of the third clamp; and
a plurality of fourth external threads threadably engaged with the fourth threaded opening of the fourth clamp, wherein the third shoulder and the fourth shoulder move from a third configuration to a fourth configuration upon a rotation of the second drive screw, and wherein the third clamp and the fourth clamp are equidistantly spaced from the second plane of symmetry in the third configuration and in the fourth configuration.

19. The mounting system of claim 18, wherein the mounting system further comprises a payload, wherein the first clamp and the second clamp are positioned to exert equal and opposite clamping forces on the payload in the second configuration, and wherein the third clamp and the fourth clamp are positioned to exert equal and opposite clamping forces on the payload in the fourth configuration.

20. The mounting system of claim 19, wherein a third plane of symmetry is defined between the first clamp and the third clamp such that the first clamp and the third clamp are equidistantly spaced from the third plane of symmetry, and wherein the first drive screw and the second drive screw extend longitudinally on opposite sides of the third plane of symmetry.
